(19) United States
(12) Patent Application Publication
(10) Pub. No.: US 2007/0144653 A1
(43) Pub. Date: Jun. 28, 2007

(54) Methods and systems for debonding substrates

(76) Inventors: Kenneth A. Padilla, Campbell, TX (US); Chad W. Grant, Campbell, TX (US); James Threlfall JR., Royse City, TX (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 11/316,380

(22) Filed: Dec. 22, 2005

(51) Int. Cl. B29C 63/00; H05B 1/02

(52) U.S. Cl. 156/64; 156/344; 219/494

(57) ABSTRACT

Methods and systems for applying heat to substrates that are in contact with an uncured bonding material or that are bonded with one or more sealants or other bonding material/s. Substrates may be heated, for example, so that the substrates may be debonded by degrading one or more mechanical properties of the bonding material/s so that the substrates may be separated. The application of heat to a substrate may be controlled based on the temperature of the substrate during the heating process. Damage-sensitive substrates, such as aircraft substrates, may be heated in a manner that controls surface temperature of the substrates to meet heat treating requirements and/or to limit heating to maximum temperatures for the substrates in a manner that substantially eliminates damage to the substrates during the heating operation while at the same time at least partially curing uncured bonding material, or degrading one or more mechanical properties of cured bonding material/s.

### FIELD OF THE INVENTION

This invention relates generally to bonded substrate materials, and more particularly to methods and systems for debonding or separating bonded substrates, or for at least partially curing uncured bonding material in contact with a substrate.

### BACKGROUND OF THE INVENTION

Damage-sensitive substrates, such as aircraft substrates, are often bonded together by sealant. One example of such sealants is polysulfide sealant that is employed to control corrosion and eliminate leaks. Such sealants may be applied to bond and seal fay surfaces of an aircraft aluminum structure in areas such as skin laps, wing skin to structure, circumferential and longitudinal skin splices, skin-to-stringer and skin-to-shear tie joints in the lower lobe of a fuselage, skin doublers, wheel well structure, spar web-to-chord and chord-to-skin joints of wing and empennage, and pressure bulkheads. Many times such sealant bonds are inaccessible to effective removal tools.

Certain methods for debonding substrates are known in the art. For example, debonding or separating aircraft substrates connected with sealant is currently achieved by wedging or prying the bonded substrates apart with a tool, such as a putty knife during the debonding process. The putty knife may be inserted between the bonded substrates and hammered along the seal plane to separate the structure. However, the use of a prying force to separate aircraft substrates often results in damage to parent material of the substrate and collateral damage to the surrounding structure of the aircraft, as well as damage to the tools employed. In an attempt to reduce damage to the aircraft structure, phenolic scrapers have been employed for separating aircraft substrates. However, phenolic scrapers have been found to be brittle.

In another debonding method, heat has been applied to bonded aircraft substrates using heat blankets that are locally placed in contact with the bonded substrates to increase the substrate temperature prior to physically separating the substrates. Using this method, thermocouples are locally placed in contact with the bonded substrates and electrically coupled to the heat blankets so as to control substrate heating (including temperature ramp up and ramp down times) based on response of the thermocouples to the substrate temperature, i.e., by turning the heat blanket off when the substrate is heated to a higher first substrate temperature and then turning the heat blanket back on when the substrate cools to a cooler second temperature. However, placement and removal of heat blankets is a time consuming process and proper placement is limited by the size of the heat blanket relative to the size and accessibility of the bonded substrates. In this regard, the location of the substrate parts being debonded directly impact heat blanket accessibility, and parts located within certain areas of an aircraft complicate the utilization of heat blankets for debonding. Placement of the heat blankets in contact with substrates on the underside of horizontally oriented areas is an awkward process since the heat blankets are pulled away from these substrates by gravity. Furthermore, the heat blankets must be physically removed from contact with the substrate prior to initiating part disbondment and separation.

Hand-held hot air guns have also been employed to heat and debond bonded substrates. In this method, application of heat by a hand-held hot air gun is manually controlled by the hot air gun human operator. In one prior method, the human operator manually controls the application of heat by manually turning the hot air gun on and off based on the human operator's best guess or estimate of when sufficient heat has been applied. In another prior method, the human operator manually controls the application of heat by manually turning the hot air gun on and off based on visual observation of a temperature indicator that is electrically connected to thermocouples locally placed in contact with the bonded substrates.

When heat-curing sealant to bond substrates together, it is known to apply heat to the substrates using heat blankets placed in contact with the substrate, or using heat lamps positioned at a suitable distance in order to radiate heat onto the substrates. To ensure that the substrate does not exceed the maximum-allowable substrate temperature during heat-curing, heat lamps must be positioned at a specific distance from the substrate or thermocouples are locally placed in contact with the substrates being bonded and electrically coupled to the heat blankets so as to control substrate heating by the heat lamps or heat blankets during heat-curing based on response of the thermocouples to the substrate temperature, i.e., by turning the heat blanket off when the substrate is heated to a higher first substrate temperature and then turning the heat blanket back on when the substrate cools to a cooler second temperature.

### SUMMARY OF THE INVENTION

Disclosed herein are methods and systems for applying heat to substrates that are bonded together with one or more sealants, adhesives, paints or other types of bonding material/s, e.g., so that the substrates may be debonded by degrading one or more mechanical properties (e.g., reducing tensile strength and/or adhesive strength) of the bonding material/s so that the substrates may be separated. The disclosed methods and systems may be employed in another embodiment to degrade one or more mechanical properties of a bonding material (e.g., to remove the bonding material) that is bonded to a substrate as a coating (e.g., such as a coating of paint where the substrate is not bonded to another substrate by the coating). In a further alternative embodiment, the disclosed methods and system may be employed to at least partially cure an uncured bonding material that is in contact with a substrate (e.g., for localized composite repairs, curing of paint coatings, curing of adhesives or sealants or other materials used to bond two substrates together, etc.).

Using the disclosed methods and systems, the application of heat to a substrate in contact with a bonding material (e.g., as a cured bonding material bonded to the substrate or as an uncured bonding material in contact with the substrate) may be controlled based on the temperature of the substrate during the heating process.

In one exemplary embodiment, damage-sensitive substrates, such as aircraft substrates (e.g., fay surfaces of an aircraft aluminum structure in areas such as skin laps, wing skin to structure, circumferential and longitudinal skin splices, skin-to-stringer and skin-to-shear tie joints in the lower lobe of a fuselage, skin doublers, wheel well structure, spar web-to-chord and chord-to-skin joints of wing and empennage, and pressure bulkheads, etc.), may be debonded and separated in a manner that controls surface temperature of the substrates to meet heat treating requirements and/or to limit heating to maximum temperatures (e.g., to not exceed maximum-allowable temperature limitations) for the substrates in a manner that substantially eliminates damage to the substrates during the debonding operation while at the same time degrading one or more mechanical properties of the bonding material/s. In such an exemplary embodiment, damage-sensitive substrates may be advantageously debonded and separated without the need for mechanical prying using a putty knife or other prying tool. Furthermore, substrates may be debonded and separated without prying tools where sealant bonds are located in areas that are inaccessible to such prying tools.

Besides aircraft substrates, other types of bonded substrates that may be heated (e.g., for debonding or curing purposes) using the disclosed methods and systems include, but are not limited to, spacecraft substrates, boat substrates, train substrates, automobile substrates, building substrates, etc.

In one embodiment, a substrate heating system may be provided for heating and debonding substrates (e.g., aircraft substrates) that are bonded together with one or more sealants or other bonding material/s. Such a substrate heating system may include a heat source (e.g., remote heat source such as a hot air nozzle or radiant heat element) and a thermal sensor (e.g., such as an infrared thermal sensor) to allow manual and/or automatic control of substrate temperature during substrate heating. A thermal sensor may be configured for physical attachment to a substrate, or may alternatively be provided as a remote thermal sensor that senses temperature level of the substrate from a distance, i.e., without physically contacting the substrate. A substrate heating system may also include an optional thermal indicator (e.g., temperature display) and/or optional heat source control (e.g., microcontroller). A thermal indicator may be present to facilitate manual control of substrate temperature during heating, and a heat source control may be present to provide automated control of substrate temperature during heating. The substrate heating system of this embodiment may alternatively be employed for at least partially curing a bonding material in contact with a substrate.

Using the disclosed methods and systems, automated control of substrate temperature may be advantageously employed to reduce or substantially eliminate temperature level errors during heating that could lead to substrate damage, such as warping of the substrate or adverse heat treating effects to the substrate that may occur when excessive heat is applied. In this regard, automated control of substrate heating may be employed to achieve substantially precise control of substrate temperature and/or to ensure compliance with desired maximum temperatures or temperature ranges. Use of remote thermal sensors to monitor temperature during heating may be advantageously employed without requiring thermocouples to be placed in contact with the substrate to monitor the temperature of the substrate. Advantageously this allows heating of composite materials for composite repairs without the presence of thermocouples that may interfere with the composite repair material.

In another embodiment, a substrate heating system may be employed using a heat source to apply sufficient amount of heat to a bonded substrate to at least partially debond the substrate from another substrate while at the same time monitoring surface temperature of the substrate using a thermal indicator and/or a heat source control coupled to a thermal sensor, and controlling the amount of heat applied to the substrate based on the monitored surface temperature of the substrate. In one exemplary embodiment, a desired maximum substrate temperature or a substrate temperature profile for debonding a particular type of substrate may determined automatically by a heat source control, and a heat source may be controlled by the heat source control to apply heat to the substrate in a manner that achieves the desired maximum substrate temperature or temperature profile for debonding the substrate. During substrate heating, substrate temperature may be monitored by a thermal sensor and the surface temperature of the substrate controlled based on the monitored temperature. Heat application may be discontinued when desired substrate debonding temperature is reached, and the substrate then separated from another substrate. Advantageously, bonded substrates may be so heated and separated relatively easily in one exemplary embodiment without the necessity of applying force or prying the substrates apart using tools such as putty knives. The substrate heating system of this embodiment may alternatively be employed for at least partially curing a bonding material in contact with a substrate.

In one embodiment, a substrate heating system may be configured as a heat gun that includes a directional remote heat source (e.g., directional hot air nozzle, directional radiant heat element, etc.) for directionally applying heat to a substrate. The heat gun may include a switch mechanism for manual activation and deactivation of the heat gun, and that may be configured, for example, as a trigger or other suitable ON/OFF switch mechanism on the heat gun. A thermal sensor (e.g., infrared sensor) attached to the heat gun may be provided configured to monitor temperature level of the substrate to which heat is applied by the heat gun. The thermal sensor may be optionally configured to detect and read temperature level on the substrate, and to indicate the temperature level on a thermal indicator (e.g., temperature display). Controls for allowing manual input and/or adjustment of heat output characteristics (e.g., heat output level) may also be provided.

In one exemplary configuration, a substrate heating system such as a heat gun may be provided with optional heat source control (e.g., microcontroller, analog control circuitry or other device or combination thereof) that is configured to automatically control heat output characteristics. A control interface may be provided for providing input parameters and/or programming information to the heat source control. For example, the control interface may be employed to allow a user to manually input the maximum substrate temperature level desired for a debonding or curing process, and/or to input or select a pre-programmed substrate temperature profile, e.g., including desired temperature level and/or heat application duration. A user may input and/or select maximum substrate temperature level and/or substrate temperature profile based on the type of material the substrate is composed of, and the heat source control may be configured to automatically control heat application to the substrate based on this user input and/or user selection. An optional display may also be provided for displaying one or more types of information such as user input data, substrate temperature information, heat profile information, temperature control menu, etc..

In one exemplary embodiment, a heat source control may be configured with pre-programmed maximum temperature level and/or temperature profile information, and further configured to allow a user to select the temperature levels and/or temperature profile using the control interface. The heat source control may be further configured to control a heat source to apply heat to a substrate based on the user selected maximum temperature level and/or temperature profile information. In one example, a heat source control may be configured to allow a user to select the type (e.g., composition) of substrate material that is being heated, and then to apply heat to the substrate in a manner calibrated for the selected material. The heat source control may be coupled to a thermal sensor that monitors substrate temperature, and the heat source control may be configured to adjust output of the heat source (e.g., by switching the heat source on/off or otherwise controlling the amount of heat output) based on the monitored substrate temperature. For example, the heat source control may be configured to switch the heat source OFF when the selected optimum debonding or curing temperature for a given substrate/bonding material combination is reached and maintained for an appropriate amount of time for debonding of the substrate or curing of an uncured bonding material in contact with the substrate to occur.

In one respect, disclosed herein is a method of separating two or more aircraft substrates bonded together by a bonding material. The method may include: providing a substrate heating system, the substrate heating system including a remote heat source, and a remote thermal sensor; remotely applying heat to at least one of the aircraft substrates, the bonding material or a combination thereof using the remote heat source; remotely monitoring a temperature of at least one of the aircraft substrates during the application of heat using the remote thermal sensor; manually or automatically controlling the application of heat based at least in part on the remotely monitored substrate temperature; and separating at least one of the aircraft substrates from at least one other of the aircraft substrates during or after the application of heat.

In another respect, disclosed herein is a method of separating two or more substrates bonded together by a bonding material. The method may include: remotely applying heat to at least one of the substrates, the bonding material or a combination thereof, monitoring a temperature of at least one of the substrates during the application of heat; controlling the application of heat in an automated manner based at least in part on the monitored substrate temperature; and separating at least one of the substrates from at least one other of the substrates during or after the application of heat.

In another respect, disclosed herein is a substrate heating system, including: a heat source configured to remotely apply heat to a substrate; a thermal sensor; and a heat source control coupled to the heat source and to the thermal sensor. The heat source control may be programmed with two or more different choices of substrate heating information, with each of the two or more different choices corresponding to a type of substrate material composition to be heated by application of heat by the heat source of the substrate heating system. The heat source control may be configured to allow a user to select one of the substrate heating information choices, and may be further configured to automatically control application of heat to a substrate by the heat source based at least in part on temperature of the substrate monitored by the thermal sensor and based at least in part on the programmed substrate heating information selected by a user. The heat source may be a remote heat source, the thermal sensor may be a remote thermal sensor, or a combination thereof.

In another respect, disclosed herein is a method of heating a substrate bonded to a bonding material. The method may include: remotely applying heat to the substrate or the bonding material; monitoring a temperature of the substrate during the application of heat; and controlling the application of heat in an automated manner based at least in part on the monitored substrate temperature to at least partially degrade one or more mechanical properties of the bonding material.

In another respect, disclosed herein is a method of heating a substrate in contact with a bonding material. The method may include: applying heat to the substrate or the bonding material; remotely monitoring a temperature of the substrate during the application of heat. The bonding material may be a cured bonding material in contact with the substrate and the method may include controlling the application of heat based at least in part on the monitored substrate temperature to at least partially degrade one or more mechanical properties of the cured bonding material, or the bonding material may be an uncured bonding material in contact with the substrate and the method may include controlling the application of heat based at least in part on the monitored substrate temperature to at least partially cure the uncured bonding material.

### BRIEF DESCRIPTION OF THE DRAWINGS

FIG. 1 shows a block diagram of a debonding process according to one exemplary embodiment of the disclosed methods and systems.

FIG. 2 shows a substrate heating system according to one exemplary embodiment of the disclosed methods and systems.

FIG. 3 shows two bonded substrates and a substrate heating system according to one exemplary embodiment of the disclosed methods and systems.

FIG. 4 is a flowchart illustrating a debonding process according to one exemplary embodiment of the disclosed methods and systems.

### DESCRIPTION OF ILLUSTRATIVE EMBODIMENTS

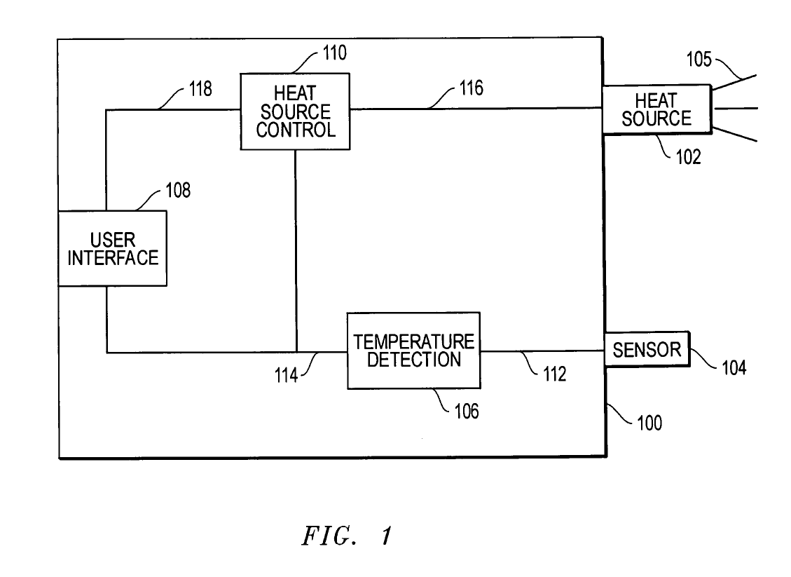

FIG. 1 shows a block diagram of a substrate heating system 100 according to one exemplary embodiment of the disclosed methods and systems that may be implemented, for example, to separate two or more substrates bonded by bonding material. As shown, system 100 includes a heat source 102 configured to emit heat 105 (e.g., radiant or convective heat), that is controlled by a heat source control 110 based at least partially on temperature information provided by temperature detector 106 and thermal sensor 104. System 100 also includes a user interface 108 that may be present, for example, to allow a user to input control information to a heat source control 110 and/or for display of heating system operation information to a user.

Still referring to FIG. 1, heat source 102 may be any one or more components suitable for remotely applying heat (e.g., radiant or convective heat) to a substrate, i.e., without making physical contact with the substrate. Examples of suitable remote heat sources include, but are not limited to, electric heating element/s, flammable gas burner/s, heat lamp/s, etc. In one embodiment heat source 102 may be configured as a forced convection hot air source that includes electric blower fan/s in combination with a heating element, gas burner, heat lamp, etc.

Thermal sensor 104 of FIG. 1 may be any sensing device suitable for sensing temperature of a substrate, remotely or by making physical contact with the substrate. Examples of suitable remote thermal sensors include, but are not limited to, infrared sensors such as of the type employed in hand-held Raytek Raynger ST-series infrared thermometers or fixed-mount Raytek Thermalert-series infrared thermometers available from, for example, Total Temperature Instrumentation, Inc. of Williston, Vt. Examples of suitable thermal sensors that sense temperature by making physical contact include, but are not limited to, thermocouples. As shown for the exemplary embodiment of FIG. 1, thermal sensor 104 may be coupled to provide a raw signal 112 that is representative of substrate temperature to temperature detector circuit 106 that may be present to receive and convert this signal to a temperature signal 114, e.g., which may then be provided to user interface 108 for display to user, and/or may be provided to heat source control 110, e.g. for further processing and utilization in the control of heat source 102.

Heat source control 110 may be any circuitry component/s suitable for controlling heat source 102 in a manner as described elsewhere herein. Heat source control 110 may include, for example, a digital processing component (e.g., CPU or microcontroller), analog control circuitry, or combination thereof that provides a digital or analog heat source control signal 116 to heat source 102 to control heat source 102 in a manner as described elsewhere herein. In one example, heat source control 110 may be a thermostat device that controls heat source 102 based on an input temperature signal 114.

In one exemplary embodiment, heat source control 110 may be configured with memory (e.g., solid state memory, magnetic or optical drive, etc.) capable of storing substrate heating information concerning maximum substrate temperature, substrate heating times and/or substrate temperature profile for one or more types of substrate and/or substrate bonding materials. For example, substrate heating information may be a maximum temperature to which a given substrate is to be heated, a substrate temperature range (i.e., minimum and maximum temperatures between which a given substrate temperature is to be maintained), maximum heating time for a given substrate, or a combination thereof. In another example, substrate heating information may be a temperature profile, e.g., a profile of temperature versus time that includes multiple temperatures in combination with time durations at which a given substrate is to be held at each of the multiple temperatures. Such a temperature profile may correspond, for example, to a heat treating schedule for a given substrate material that maintains the desired mechanical properties of the substrate material. A digital processing component may also be present within heat source control 110, e.g., to implement the substrate temperature, substrate heating duration or substrate temperature profile included in the substrate heating information, or to otherwise calculate or determine substrate temperature, substrate heating duration or substrate temperature profile based on the substrate heating information stored in memory of control component 110.

User interface 108 of FIG. 1 may include any component/s (e.g., digital or analog temperature display) suitable for displaying temperature information based on temperature signal 114 and/or any component/s (e.g., keypad, interactive graphical display, toggle switch, etc.) suitable for accepting control information from a user and for providing this as a control signal 118 to heat source control 110. In one embodiment, user interface 108 may also display information (e.g. menu-based command information) for controlling heat source control 110. For example, components of substrate heating system 100 may be configured in one exemplary embodiment to allow a user to manually enter substrate heating information and provide this information to heat source control 110. In another exemplary embodiment, components of substrate heating system 100 may be configured to allow a user to select or enter a particular substrate material (e.g., aluminum substrate, steel substrate, fiberglass substrate, etc.) into user interface 108, and heat source control 110 configured to implement the particular substrate temperature, heating times and/or substrate temperature profile based on this user selection or entry.

It will be understood that FIG. 1 is exemplary only and that any other system configuration or fewer, additional and/or alternative components may be employed that is suitable for implementing the disclosed methods and systems as described elsewhere herein. For example, the tasks of temperature detector 106 and thermal sensor 104 may be integrated into a single component, or the tasks of temperature detector 106 may be integrated within user interface 108 and/or heat source control 110, e.g., so that thermal sensor 104 may be coupled directly to heat source control 110 and/or user interface 108. Furthermore, it will be understood that presence of heat source control 110 is optional, e.g., a user may directly control heat source 102 by means of ON/OFF switch, rheostat, etc. based on temperature information displayed to the user by user interface 108. Alternatively, heat source 102 may be controlled automatically by heat source control 110 without user input or display to user.

In one exemplary embodiment, substrate heating system 100 may be provided with a suitable heat source and a thermal sensor 104 that is an infrared sensor. Temperature on a given substrate may be detected, read, and/or monitored via infrared sensor 104, temperature detector 106 and user interface 108, while heat source control 110 determines and controls the amount of heat 105 applied to a given substrate based on input from a user regarding temperature levels and duration of heat application. For example, a user may input specific temperature and heating time information, or may program heat source control 110 via user interface 108 with substrate profiles, including temperature and duration levels for debonding a particular bonded substrate material type, or for curing an uncured bonding material in contact with a particular substrate material type. Heat source control 110 may then control the amount and/or time duration of heat 105 released from substrate heating system 100 and applied to the substrate. For example, in one exemplary debonding embodiment, a temperature profile for a particular combination of specific bonding material and substrate material type may be programmed into heat source control 110 via user interface 108, i.e., to heat the substrate to between 150 degrees and 180 degrees, hold at 180 degrees for one hour, then turn off. Alternatively, a user may manually set a temperature level and program the heat source control 110 via user interface 108 to hold a particular temperature for a set amount of time before turning off heat 105, or a user may manually monitor application of heat 105 via user interface 108 and then turn heat source 102 off as user desires.

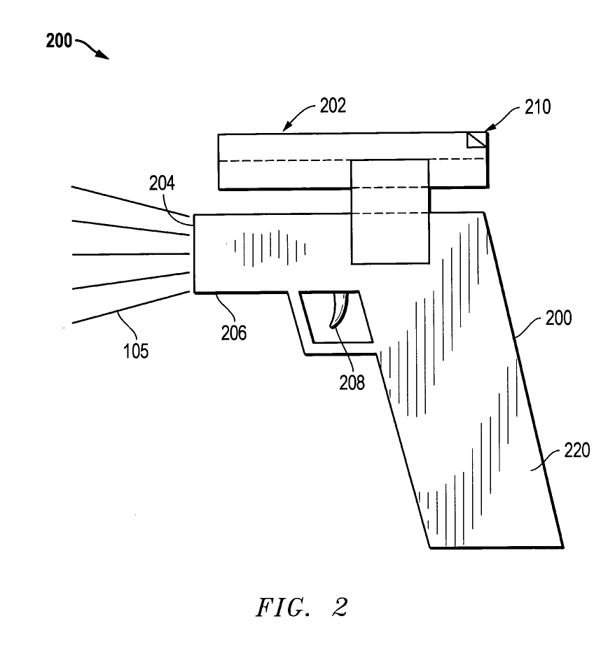

FIG. 2 shows a substrate heating system as it may be configured as a heat gun 200 in one exemplary embodiment. As shown in FIG. 2, heat gun 200 includes a heat source in the form of barrel 206 that produces heat 105 (e.g., in the form of radiant heat energy or convective hot air) that is released through a nozzle opening 204 at the end of a barrel 206). Heat gun 200 includes a hand grip 220 that may be present to allow a human user to hold and point barrel 206 of heat gun 200 for directional application of heat to a desired substrate location. Heat gun 200 is also provided with a remote thermal sensor 202 (e.g., in the form of infrared sensor) that is physically coupled to barrel 206 for remotely sensing temperature in the direction in which heat 105 is applied.

In the illustrated exemplary embodiment of FIG. 2, heat gun 200 includes a user interface 210 that is present to allow a human user to control and/or program application of heat by heat source 206 so as to achieve optimum heat levels achieved that allow for debonding and separation of particular substrates, or for curing of uncured bonding material in contact with a substrate, while avoiding substrate damage from excessive heat. For example, user interface 210 may include a display for indicating temperature level measured by thermal sensor 202, and a switch (e.g., ON/OFF, rheostat or multi-state switch) that together may be used by a human user to manually control application of heat based on displayed measured temperature. An optional ON/OFF trigger switch 208 may be provided in one exemplary embodiment. Such an embodiment may be implemented, for example, without the presence of a heat source control 110.

In another embodiment, heat gun 200 may include a heat source control 110 (not shown in FIG. 2) that may be present to automatically shut down and/or regulate heat source 206 based on temperature level monitored by thermal sensor 202 in a manner as described elsewhere herein. In the latter example, user interface 210 may also or alternatively be configured as a programming interface to allow a user to program substrate heating information (e.g., maximum substrate temperature, temperature profile, heating time, etc.) into heat source control 110.

In one exemplary embodiment, heat gun 200 may include a heat source control 110 that may be digitally programmed with a substrate-dependent maximum substrate temperature input by a user via user interface 210 in order to calibrate heat gun 200 for heating any chosen type of particular substrate material during debonding or curing operations. For example, heat source control 110 may be so implemented to control heat released during a debonding process, and to discontinue the heat application when the maximum temperature is reached, e.g., allowing for easy separation of substrates. Examples of such maximum substrate temperatures include, but are not limited to, 190° F. (or from about 180° F. to about 200° F.) for de-bonding aluminum substrates, 340° F. (or from about 330° F. to about 350° F.) for de-bonding steel substrates, and 175° F. (or from about 165° F. to about 185° F.) for de-bonding fiberglass substrates, etc. In this exemplary embodiment, thermal sensor 202 senses temperature continuously and heat source control may control heat source 206 by shutting off heat source 206 when programmed maximum substrate temperature is sensed.

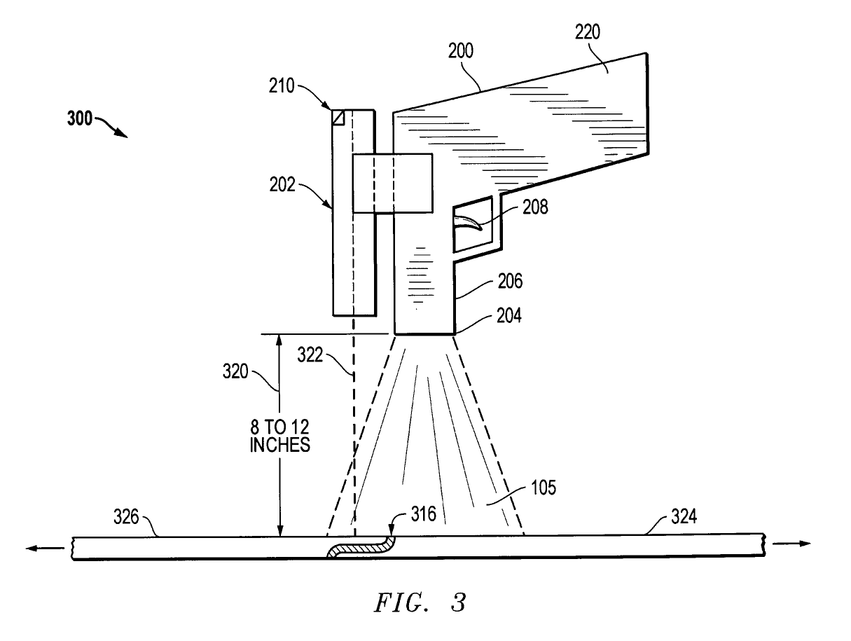

FIG. 3 shows heat gun 200 of FIG. 2 operably disposed adjacent two bonded substrates 324 and 326 (e.g., aluminum aircraft substrates) according to one exemplary embodiment of the disclosed methods and systems. As shown, heat gun 200 is positioned so that opening 204 of heat source 206 is separated from substrates 324 and 326 by a distance of from about 8 to 12 inches, although any other distance suitable for providing sufficient heat over a desired substrate heating area may be employed. In FIG. 3, heat 105 is being applied to substrates 324 and 326 in order to heat bonding material 316 (e.g., polysulfide sealant, polythioether sealant, epoxy adhesive, urethane adhesive, etc.) that bonds first substrate 324 to second substrate 326 together so that mechanical properties of bonding material 316 are sufficiently degraded (e.g., tensile strength and/or adhesive strength are reduced) to allow substrates 324 and 326 to be separated. In one exemplary embodiment, substrates 324 and 326 may be so heated and separated without requiring physical prying or use of prying tools to separate substrates 324 and 326, although use of physical prying and/or tools may be employed in conjunction with heat gun 200 in other embodiments. It will be understood that substrates 324 and 326 may be parts of two different and separate components, or may be separate parts of the same single component.

As shown in FIG. 3, opening 204 at the end of a barrel 206 is oriented by a human user to directional releases heat 105 to heat substrates 324, 326 and bonding material 316. Temperature of substrates 324 and/or 326 may be monitored by thermal sensor 202, and application of heat 105 to substrates 324 and 326 may be controlled by user interface 210 and/or heat source control 110 of FIG. 1 in a manner as described elsewhere herein. In the illustrated embodiment thermal sensor 202 may be an infrared sensor that is capable of monitoring substrate temperature via infrared radiation 322 emanating from substrate 324 and/or 326 as shown without being substantially affected by applied heat 105 present between substrate 324 and/or 326 and sensor 322. As described elsewhere herein, once substrates 324 and 326 are heated sufficiently (e.g., maximum substrate temperature is reached), heat source 206 may be switched off to discontinue application of heat 105. Substrate 326 may then be separated from substrate 324, e.g., in the direction of the arrows.

Although FIGS. 2 and 3 illustrate an exemplary configuration of a substrate heating system having components that are integrated together in the form of a heat gun device, it will be understood that the disclosed methods and systems may be implemented using substrate heating systems configured in any other form suitable for heating substrates and/or bonding materials in a manner as described elsewhere herein. Examples of other suitable configurations include substrate heating systems configured with two or more physically separate or non-integrated components that are in wired or wireless signal communication with each other (e.g., physically separate heat source and physically separate thermal sensor in signal communication with each other), or integrated substrate heating systems configured in a form other than a heat gun. In this regard, a substrate heating system may be configured as a non-hand-held device that may be, for example, a fixed/mounted or portable apparatus that is positionable for heating and debonding substrates.

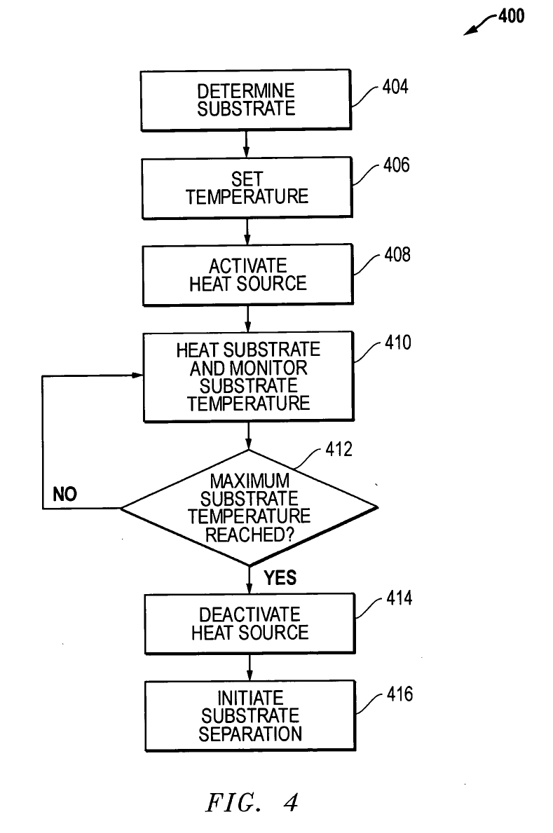

FIG. 4 is a flowchart 400 illustrating one exemplary embodiment for debonding substrates (e.g., such as substrates 324 and 326 of FIG. 3 that are bonded together with bonding material 316) as it may be implemented using a substrate heating system (e.g., such as heat gun 200 of FIG. 2) with automated control of substrate temperature during heating. However, it will be understood that in another embodiment a user may monitor displayed substrate temperature and manually control the application of heat based on the monitored substrate temperature, e.g., by manually turning the heat source off and on.

In the first step 404 of FIG. 4, a user determines the type of bonded substrate material (e.g., aluminum, steel, fiberglass, etc.) to be debonded. Next, in step 406 maximum temperature based on the type of substrate determined in step 404 is set by input or programming into a user interface (e.g., user interface 210 of heat gun 200). This may be done, for example, by manually entering the maximum temperature into the user interface, or by selecting from a menu of pre-programmed substrate temperatures offered by the user interface. The heat source (e.g., barrel 206 of heat gun 200) is then activated in step 408, and the substrate is heated in step 410. Temperature of the substrate is monitored during substrate heating by a thermal sensor (e.g. thermal sensor 202 of heat gun 200). Heating continues as long as substrate temperature remains below maximum substrate temperature, as shown in step 412. A heat source control 110 (e.g., as shown in FIG. 1) automatically turns off the heat source in step 414 once the maximum substrate temperature is reached, and separation of the substrates is initiated in step 416, e.g., by manually pulling the substrates apart or other suitable method.

It will be understood that the methodology of FIG. 4 is exemplary only, and that fewer, additional and/or alternative steps may be employed in the practice of the disclosed methods and systems. For example, although the exemplary embodiment of FIG. 4 relates to methodology in which a substrate is heated to a maximum substrate temperature and the substrates then debonded, it will be understood that in other embodiments substrate temperature may be controlled prior to or during substrate separation based on other types of substrate heating information, e.g., maximum temperature to which a given substrate is to be heated, a substrate temperature range within which a substrate temperature is to be maintained (e.g., by heating the substrate to a higher first temperature, then allowing the substrate to cool to a lower second temperature, and then applying heat to the substrate again to heat the substrate to the higher first temperature and continuing to cycle application of heat to the substrate in this manner as needed or desired), maximum heating time for a given substrate, or a combination thereof. Furthermore, similar methodology may be employed to at least partially cure uncured bonding material in contact with a substrate, e.g., without step 416.

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed methods and systems may be utilized in various combinations and/or independently. Thus the invention is not limited to only those combinations shown herein, but rather may include other combinations.

What is claimed is:

1. A method of separating two or more aircraft substrates bonded together by a bonding material, said method comprising:
providing a substrate heating system, said substrate heating system comprising a remote heat source, and a remote thermal sensor;
remotely applying heat to at least one of said aircraft substrates, said bonding material or a combination thereof using said remote heat source;
remotely monitoring a temperature of at least one of said aircraft substrates during said application of heat using said remote thermal sensor;
manually or automatically controlling said application of heat based at least in part on said remotely monitored substrate temperature; and
separating at least one of said aircraft substrates from at least one other of said aircraft substrates during or after said application of heat.

2. The method of claim 1, further comprising controlling said application of heat based at least in part on said monitored substrate temperature to at least partially degrade one or more mechanical properties of said bonding material.

3. The method of claim 1, wherein said substrate heating system further comprises a heat source control; wherein said remote heat source comprises a hot air source; wherein said remote thermal sensor comprises an infrared sensor; and wherein said method comprises automatically controlling said application of heat with said heat source control based at least in part on said remotely monitored substrate temperature.

4. The method of claim 3, wherein said heat source, said thermal sensor, and said heat source control are integrated together into a substrate heating system configured as a heat gun.

5. The method of claim 3, wherein said method comprises automatically controlling said remote application of heat with said heat source control based at least in part on said remotely monitored substrate temperature and based at least in part on substrate heating information.

6. The method of claim 5, wherein said substrate heating information comprises a maximum substrate temperature; and wherein said automatically controlling said application of heat based at least in part on said remotely monitored substrate temperature comprises automatically discontinuing application of said heat when said remotely monitored substrate temperature reaches said maximum substrate temperature.

7. The method of claim 5, wherein said substrate heating information comprises a temperature profile; and wherein said automatically controlling said remote application of heat comprises automatically varying said application of said heat according to said temperature profile.

8. The method of claim 5, further comprising receiving at least a part of said substrate heating information through a user interface of said substrate heating system.

9. A method of separating two or more substrates bonded together by a bonding material, said method comprising:
remotely applying heat to at least one of said substrates, said bonding material or a combination thereof;
monitoring a temperature of at least one of said substrates during said application of heat;
controlling said application of heat in an automated manner based at least in part on said monitored substrate temperature; and
separating at least one of said substrates from at least one other of said substrates during or after said application of heat.

10. The method of claim 9, further comprising controlling said application of heat in an automated manner based at least in part on said monitored substrate temperature to at least partially degrade one or more mechanical properties of said bonding material.

11. The method of claim 9, wherein said monitoring a temperature of at least one of said substrates comprises remotely monitoring a temperature of at least one of said substrates during said application of heat.

12. The method of claim 9, wherein said substrates comprise aircraft substrates.

13. The method of claim 1l, wherein said remotely applying heat comprises applying hot air to at least one of said substrates, said bonding material or a combination thereof; and wherein said monitoring a temperature of at least one of said substrates comprises monitoring infrared radiation emitted by at least one of said substrates.

14. The method of claim 11, further comprising controlling said application of heat in an automated manner based at least in part on said monitored substrate temperature and based at least in part on substrate heating information selected based on a material composition of said at least one substrate.

15. The method of claim 14, wherein said substrate heating information comprises a maximum substrate temperature; and wherein said controlling said application of heat based at least in part on said monitored substrate temperature comprises discontinuing application of said heat when said monitored substrate temperature reaches said maximum substrate temperature.

16. The method of claim 14, wherein said substrate heating information comprises a temperature profile; and wherein said controlling said application of heat in an automated manner comprises varying said application of said heat according to said temperature profile.

17. The method of claim 14, wherein a heat source of a substrate heating system is used to remotely apply said heat; wherein a thermal sensor of substrate heating system is used to monitor said substrate temperature; and wherein a heat source control of said substrate heating system is use to automatically control said application of said heat.

18. The method of claim 17, wherein said heat source, said thermal sensor, and said heat source control are integrated together into a substrate heating system configured as a heat gun.

19. A substrate heating system, comprising:
a heat source configured to remotely apply heat to a substrate;
a thermal sensor; and
a heat source control coupled to said heat source and to said thermal sensor, said heat source control being programmed with two or more different choices of substrate heating information, each of said two or more different choices corresponding to a type of substrate material composition to be heated by application of heat by said heat source of said substrate heating system;
wherein said heat source control is configured to allow a user to select one of said substrate heating information choices;
wherein said heat source control is further configured to automatically control application of heat to a substrate by said heat source based at least in part on temperature of said substrate monitored by said thermal sensor and based at least in part on said programmed substrate heating information selected by a user; and
wherein said heat source comprises a remote heat source, or wherein said thermal sensor comprises a remote thermal sensor, or a combination thereof.

20. The system of claim 19, further comprising a user interface coupled to said heat source control to allow a user to select one of said substrate heating information choices corresponding to said substrate to be heated.

21. The system of claim 20, wherein said remote heat source comprises a hot air source; and wherein said thermal sensor comprises an infrared sensor.

22. The system of claim 21, wherein said heat source, said thermal sensor, and said heat source control are integrated together into a substrate heating system configured as a heat gun.

23. The system of claim 19, wherein said programmed substrate heating information comprises a maximum substrate temperature; and wherein said heat source control is configured to automatically discontinue application of said heat to said substrate when said monitored substrate temperature reaches said maximum substrate temperature.

24. The system of claim 19, wherein said programmed substrate heating information comprises a temperature profile; and wherein said heat source control is configured to automatically vary said remote application of said heat to said substrate according to said temperature profile.

25. A method of heating a substrate bonded to a bonding material, said method comprising:
remotely applying heat to said substrate or said bonding material;
monitoring a temperature of said substrate during said application of heat; and
controlling said application of heat in an automated manner based at least in part on said monitored substrate temperature to at least partially degrade one or more mechanical properties of said bonding material.

26. The method of claim 25, wherein said substrate comprises an aircraft substrate; wherein said monitoring a temperature of at least one of said substrates comprises remotely monitoring a temperature of at least one of said substrates during said application of heat; and wherein said method further comprises controlling said application of heat in an automated manner based at least in part on said monitored substrate temperature and based at least in part on substrate heating information selected based on a material composition of said substrate.

27. The method of claim 26, wherein said substrate heating information comprises a maximum substrate temperature; and wherein said controlling said application of heat based at least in part on said monitored substrate temperature comprises discontinuing application of said heat when said monitored substrate temperature reaches said maximum substrate temperature.

28. The method of claim 26, wherein said substrate heating information comprises a temperature profile; and wherein said controlling said application of heat comprises varying said application of said heat according to said temperature profile.

29. The method of claim 26, wherein said remotely applying heat comprises applying hot air from a heat source of a substrate heating system to said substrate or said bonding material; wherein an infrared thermal sensor of said substrate heating system is used to monitor said substrate temperature; wherein a heat source control of said substrate heating system is use to automatically control said application of said heat; and wherein said substrate heating system comprises a heat gun.

30. A method of heating a substrate in contact with a bonding material, said method comprising:
applying heat to said substrate or said bonding material;
remotely monitoring a temperature of said substrate during said application of heat; and
wherein said bonding material is a cured bonding material in contact with said substrate and said method comprises controlling said application of heat based at least in part on said monitored substrate temperature to at least partially degrade one or more mechanical properties of said cured bonding material, or
wherein said bonding material is an uncured bonding material in contact with said substrate and said method comprises controlling said application of heat based at least in part on said monitored substrate temperature to at least partially cure said uncured bonding material.

31. The method of claim 30, wherein said substrate comprises an aircraft substrate; and wherein said method further comprises controlling said application of heat in an automated manner based at least in part on said monitored substrate temperature and based at least in part on substrate heating information selected based on a material composition of said substrate.

32. The method of claim 31, wherein said substrate heating information comprises a maximum substrate temperature; and wherein said controlling said application of heat based at least in part on said monitored substrate temperature comprises discontinuing application of said heat when said monitored substrate temperature reaches said maximum substrate temperature.

33. The method of claim 31, wherein said substrate heating information comprises a temperature profile; and wherein said controlling said application of heat comprises varying said application of said heat according to said temperature profile.

34. The method of claim 31, wherein said applying heat comprises remotely applying heat to said substrate or said bonding material.

35. The method of claim 34, wherein said remotely applying heat comprises applying hot air from a heat source of a substrate heating system to said substrate or said bonding material; wherein an infrared thermal sensor of said substrate heating system is used to monitor said substrate temperature; wherein a heat source control of said substrate heating system is use to automatically control said application of said heat; and wherein said substrate heating system comprises a heat gun.
